(19) United States
(12) Patent Application Publication
(10) Pub. No.: US 2003/0236697 A1
(43) Pub. Date: Dec. 25, 2003

(54) System and method for on-line analysis and reporting of financial operation data from community pharmacies

(76) Inventor: Michael T. Rupp, Glendale, AZ (US)

Correspondence Address: WEISS & MOY PC, 4204 NORTH BROWN AVENUE, SCOTTSDALE, AZ, 85251, US

(21) Appl. No.: 10/180,400

(22) Filed: Jun. 25, 2002

(51) Int. Cl. G06F 17/60

(52) U.S. Cl. 705/10

(57) ABSTRACT

A system for collection and analysis of operational and financial data from community pharmacies has an information server for storing and receiving data related to operating the community pharmacy and for performing a cost of dispensing analysis and financial ratio analysis of the data and for providing reports to individual and group users that allows them to compare their results with data derived from other similar pharmacies. A monitor is used to view the data stored and entered on the information server. An information server access box is coupled to the monitor and to the information server. The information server access box is used for accessing the information server and for transferring data to and from the information server.

### BACKGROUND OF THE INVENTION

1. Field of the Invention

This invention relates to operating costs of community pharmacies, and more specifically, to a system and method for on-line analysis and reporting of financial operation data from community pharmacies in order to perform a cost comparison analysis.

2. Description of the Prior Art

The price of a retail prescription in a community setting generally has four components: 1) acquisition cost of the medication (i.e., ingredient cost); 2) cost of stocking, repackaging, labeling, and dispensing the medication; 3) cost to perform necessary professional services such as drug utilization review and patient counseling; and 4) a fair return on investment (net profit). Historically, components 2 and 3 have been combined under the broad heading “cost of dispensing.”

Currently, approximately 75% of prescriptions dispensed by independent community pharmacies are paid through public (i.e., Medicaid) and private third party insurance programs. Typically, these insurance programs pay pharmacists on the basis of an estimated ingredient cost plus a dispensing fee. The estimated ingredient cost is calculated as a discount on published average wholesale price (AWP), and is intended to reflect the pharmacy's actual acquisition cost. The dispensing fee is intended to cover the cost to dispense the medication and a fair profit.

Fueled in part by intense competition between prescription benefit management firms (PMBs), private third party reimbursement rates have grown progressively less profitable over the past two decades. As PBM contracts have demanded increasingly higher discounts on AWP, they have concurrently cut down dispensing fees to pharmacies.

On the public insurance side, each year Medicaid administrators in several states make a bid to balance their budget by reducing prescription reimbursement to pharmacists.

Given the history of third party prescription payment, pharmacy organizations will continue to experience threats to both the ingredient component of prescription reimbursement, and to the dispensing fee component. With respect to the dispensing fee, individual community pharmacy organizations need accurate and timely information about their internal costs of dispensing if they are to make rational decisions regarding whether to participate in a particular third party prescription drug plan. Collectively, organized pharmacies need access to such information. This is especially true at the state level where state Medicaid authorities continue to try and reduce prescription drug costs.

In addition to cost of dispensing information, community pharmacies would also benefit from the ability to have key financial ratios and other operational indicators reported. Moreover, pharmacies would benefit from the ability to compare (i.e., benchmark) their store's cost of dispensing and financial ratio values to those derived from similar pharmacies.

Historically, pharmacies that wished to know their internal cost of dispensing had to collect and analyze the data themselves, or hire an analyst to design and conduct an analysis. Despite the recognized value of having routine cost of dispensing and financial ratio information, few individual pharmacies or pharmacy groups (e.g., local, state, and national pharmacy organizations and associations) have had such analyses conducted. Barriers to routine cost of dispensing and financial ratio analysis have included the time, costs, and technical expertise required to properly collect and analyze the required information and report the results in an easily interpreted format.

Therefore, a need existed to provide a computer software application and associated on-line service that allows for the collection and analysis of operational and financial data from community pharmacies. The computer software application and associated on-line service must further allow users the ability to input data and compare data from individual pharmacies and/or groups of pharmacies with data derived from other similar pharmacies.

### SUMMARY OF THE INVENTION

In accordance with one embodiment of the present invention, it is an object of the present invention to provide a computer software application and associated on-line service that allows for the collection and analysis of operational and financial data from community pharmacies.

It is another object of the present invention to provide a computer software application and associated on-line service that allows users, both individually and by defined groups, the ability to input data and compare their data with that derived from other similar pharmacies.

### BRIEF DESCRIPTION OF THE EMBODIMENTS

In accordance with one embodiment of the present invention, a system for collection and analysis of operational and financial data from community pharmacies is disclosed. The system has an information server for storing and receiving data related to operating the community pharmacy and for performing a cost of dispensing analysis and financial ratio analysis of the data. A monitor is used to view the data stored and entered on the information server. An information server access box is coupled to the monitor and to the information server. The information server access box is used for accessing the information server and for transferring data to and from the information server.

In accordance with another embodiment of the present invention a computer program product for use with a graphics display device is disclosed. The computer program product has a computer usable medium having computer readable program code embodied in the medium for storing and receiving data related to operating a community pharmacy and for performing a ratio analysis of the data. Computer readable program code means are provided for calculating cost of dispensing values and ratio analysis related to solvency and liquidity of the community pharmacy. Computer readable program code means are provided for calculating ratio analysis related to efficiency of the community pharmacy. Computer readable program code means are provided for calculating ratio analysis related to profitability and performance of the community pharmacy.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of the on-line analysis system of the present invention.

FIG. 2 is a listing of some of the identification information that is entered into the system depicted in FIG. 1.

FIG. 3 is a listing of some of the demographic information that is entered into the system depicted in FIG. 1.

FIG. 4 is a listing of some of the operations information that is entered into the system depicted in FIG. 1.

FIG. 5 is a listing of some of the operations information that is entered into the system depicted in FIG. 1.

FIG. 6 is a listing of some of the operations information that is entered into the system depicted in FIG. 1.

FIG. 7 is a listing of some of the financial and operations information that is entered into the system depicted in FIG. 1.

### DETAILED DESCRIPTION OF THE PREFERRED EMBODIMENT

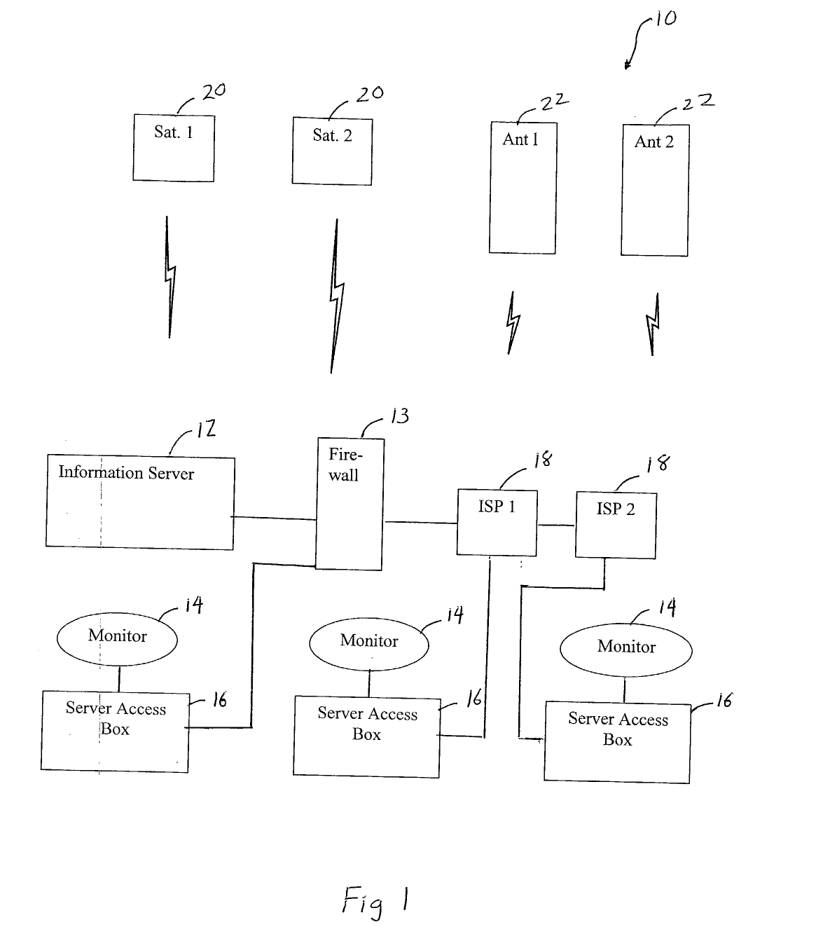

Referring to FIG. 1, a simplified block diagram of one embodiment of the pharmacy analysis system 10 (hereinafter system 10) is shown. The system 10 may be a hard wired system, a wireless system, or a combination of both wired and wireless. The system 10 will have one or more information servers 12. The information server 12 may be protected by a firewall 13 to prevent unauthorized personnel from accessing the information server 12. The information server 12 is programmed to collect and analyze operational and financial data from community pharmacy users. The information server 12 will further allow users the ability to input data and compare data with other similar pharmacies.

In order to view the data stored in the information server 12, a monitor 14 is used. The monitor 14 may be a computer monitor, a television, a video display, or the like. The monitor 14 may be located in the privacy of your home, a pharmacy, or any other location. The monitor 14 is coupled to a web access terminal 16. The web access terminal 16 will allow one to access the information server 12. The web access terminal 16 may directly access the information server 12 or the web access terminal 16 may access the information server via an Internet Service Provider (ISP) 18. The web access terminal 16 may access the information server 12 an/or the ISP 18 by wired or wireless means. Wired means may include telephone lines, cable lines, and the like. If a wireless means is used, data is transmitted via satellites 20, antennas 22, or like devices.

Once a user accesses the information server 12, the user must enter an access code in order to input and view information stored on the information server 12. The information server 12 is programmed to provide an individual pharmacy report detailing the operational and financial situation of the pharmacy and a comparison with pharmacies in the database that are similar with respect to Total Sales, Prescription Volume, Size (sq. ft.), Location, Technology Used in the Pharmacy, and Location.

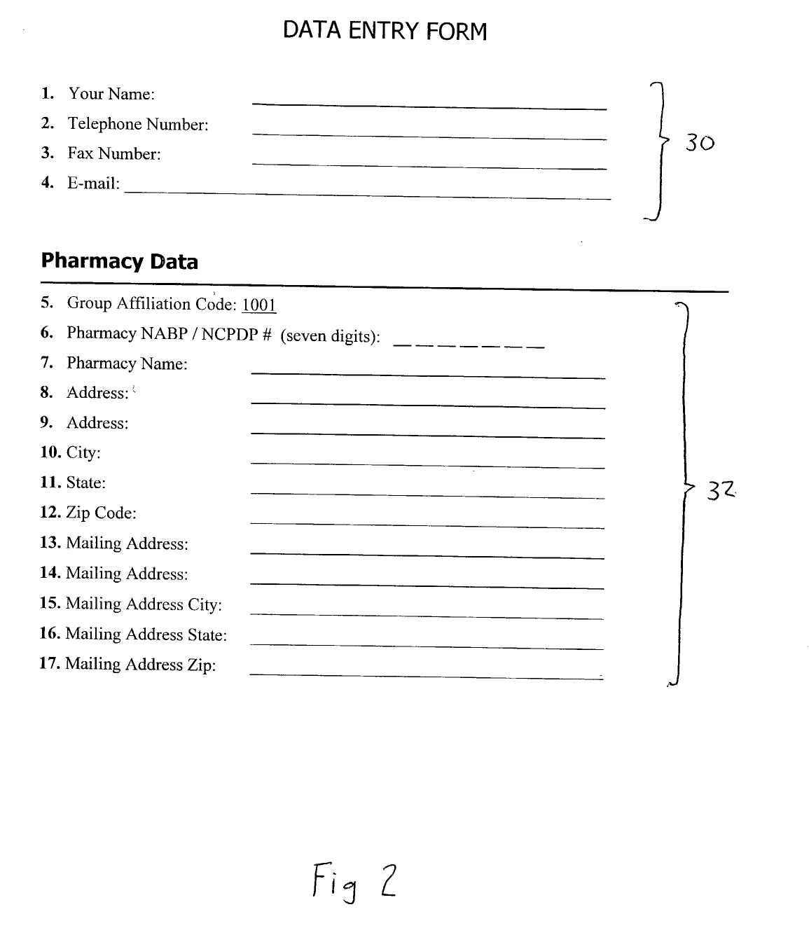

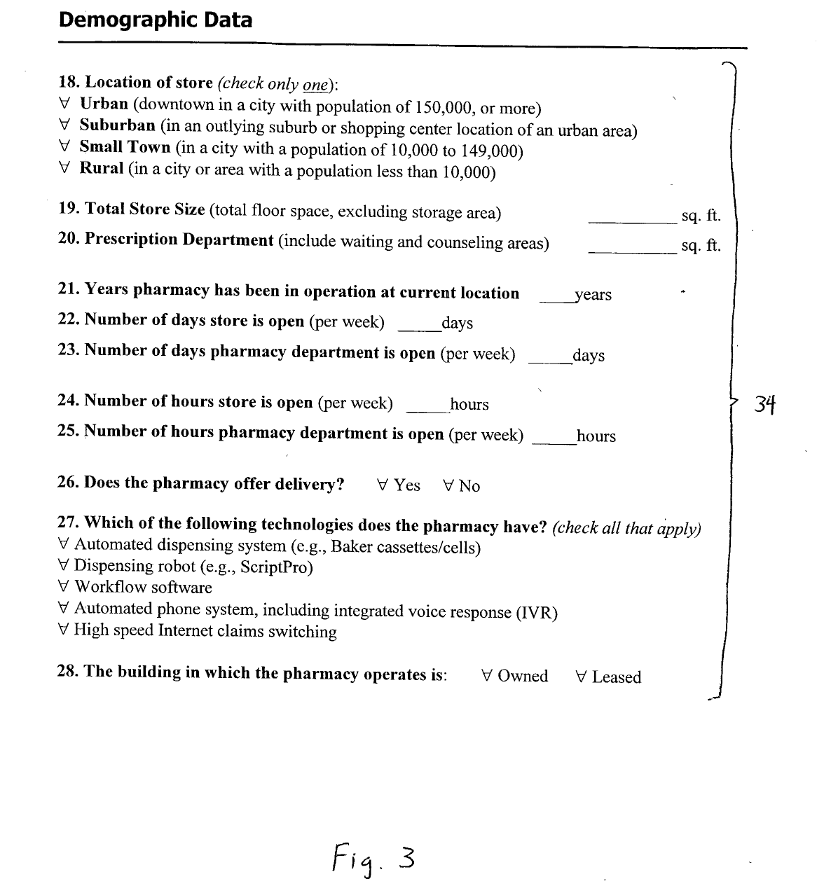

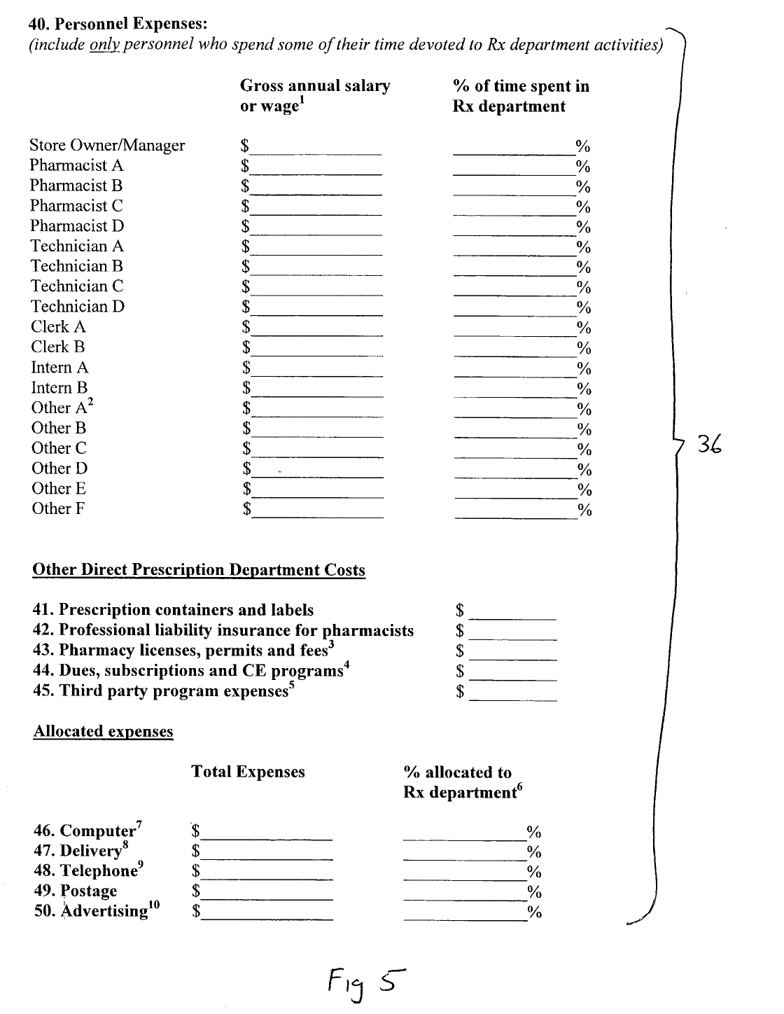

The information server will detail the cost of dispensing (COD) value for the pharmacy. The COD value is determined by the user inputting data to a plurality of different questions which the information server 12 will display on the monitor 14 of the user. FIGS. 2-5 show different data which an individual pharmacy would input. As shown in FIG. 2, the pharmacy will first input some general identifying information 30. The general identifying information 30 may include the contact information of the user's. For example, the user may have to input his name, telephone number, email address, identification number, etc. It should be noted that other general identifying information 30 may be included without departing from the spirit and scope of the present invention. The general identifying information 30 is used to monitor who is accessing and using the system 10 and whether or not the user is authorized to access the data.

The user will then be asked to input general contact information 32 regarding the pharmacy. The general contact information 32 may include pharmacy name, address, phone number, group affiliation code, pharmacy NABP/NCPDP #, etc. Once again, it should be noted that other general contact information 32 may be included without departing from the spirit and scope of the present invention. The general contact information 32 is used to identify the particular pharmacy for which data is being entered.

Once the general contact information 32 is entered, the user will input demographic data 34 relating to the pharmacy. The demographic data may include, location and size of the store, size of the pharmacy if part of a larger store, years in operation, number of days open, technology used by the pharmacy, etc. Once again, it should be noted that other types of demographic data may be included without departing from the spirit and scope of the present invention.

Once the above information is inputted into the program, it will be saved by the information server 12. When a user accesses the pharmacy account, this information does not need to be reentered. However, the program is designed to allow the user to modify any of the above information at any time.

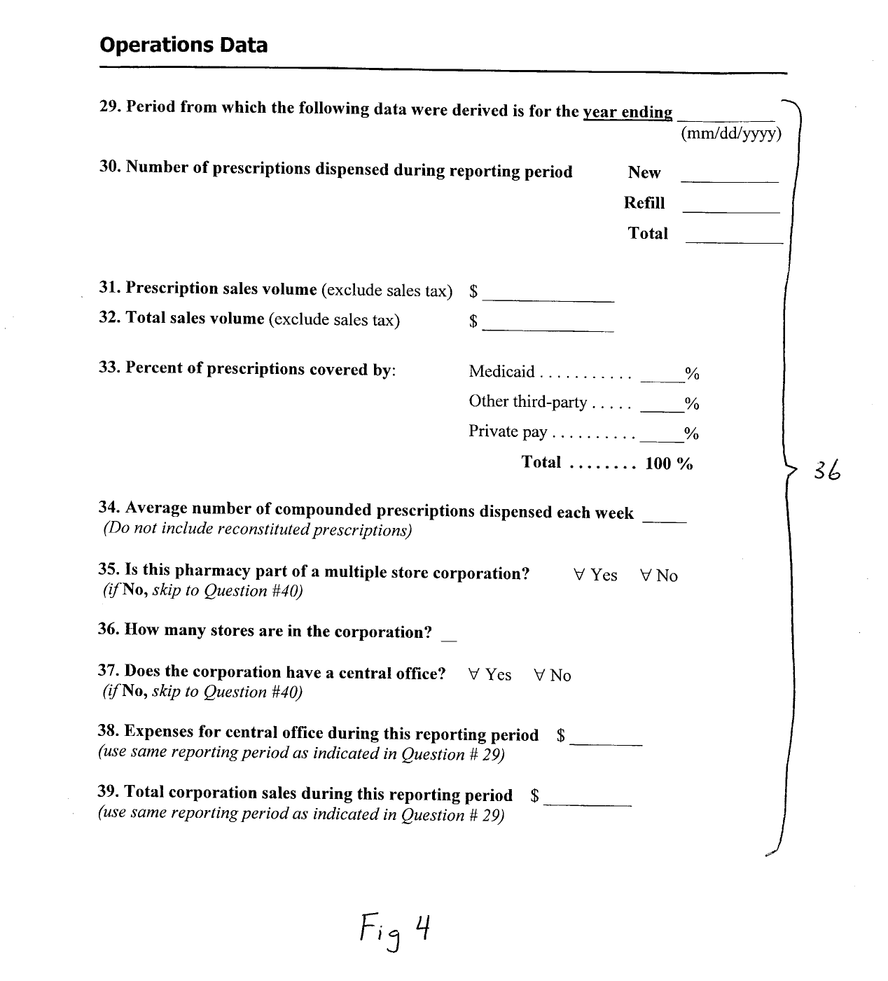

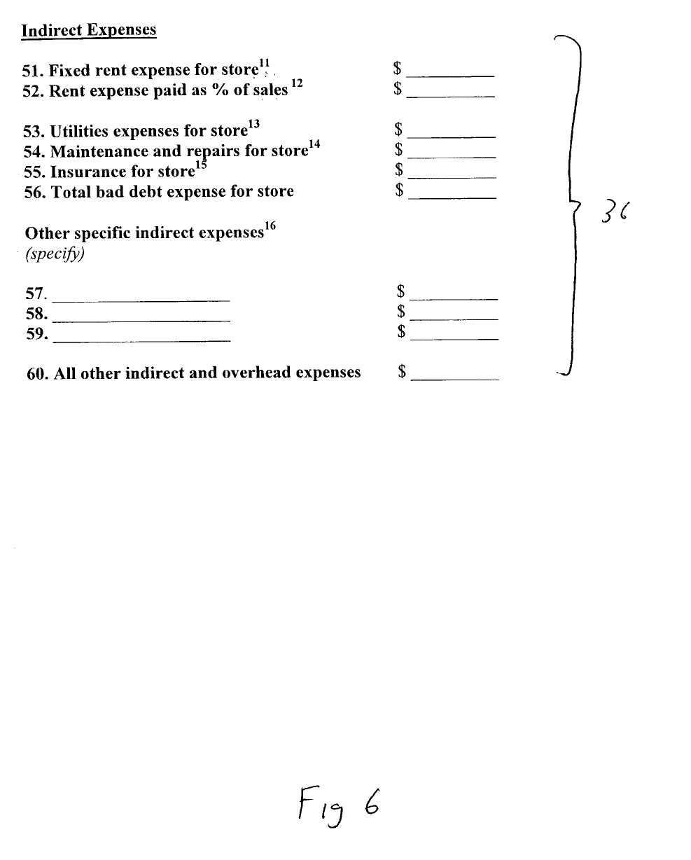

In order to provide an individual pharmacy report detailing the operational and financial situation of the pharmacy, the user must enter operation data 36 related to the pharmacy for a particular time period (i.e., monthly, quarterly, annually, etc.). The operation data 36 is used by the program to perform the analysis of the operational and financial data from the pharmacy. The operations data 36 that needs to be entered is shown in FIGS. 4-6. The operation data that is entered includes, but is not limited to: time period for which data were collected; total number of prescriptions filled during that time period including new orders and refill orders; prescription sales volume (excluding sales tax); total sales volume (excluding sales tax); percent of prescriptions covered by third party payors (i.e, percent covered by Medicaid, percent covered by other third party insurers, and percent covered by private payors); number of compound prescriptions dispensed each week, whether the pharmacy is part of a chain of stores, expenses for the central office for the reporting period, total corporate sales during the reporting period, and personnel expenses. Personnel expenses would include the gross annual salary for the owner, pharmacists, technician, clerks, and other employees. Once again, it should be noted that other types of personnel expenses may be included without departing from the spirit and scope of the present invention.

Other types of expenses must also be considered. Thus direct prescription department costs must be inputted. This type of information would include, but is not limited to: cost of prescription containers and labels, professional liability insurance, pharmacy licenses, permits and fees, due, subscriptions and continuing education costs, and other related expenses. Once again, it should be noted that other types of direct prescription department costs may be included without departing from the spirit and scope of the present invention.

Allocated expenses may also be considered. Allocated expenses include, but is not limited to, the cost of the computer, delivery charges, telephone bill, postage, advertising costs, and the like. Other types of allocated expenses may be included without departing from the spirit and scope of the present invention.

Other types of expenses to consider are indirect expenses. Indirect expenses include such expenses such as: fixed rent expenses, rent expenses paid as a percentage of sales, utilities, maintenance and repair of the store, insurance, bad debt expenses, and the like. Other types of indirect expenses 42 may be included without departing from the spirit and scope of the present invention. Page: 12

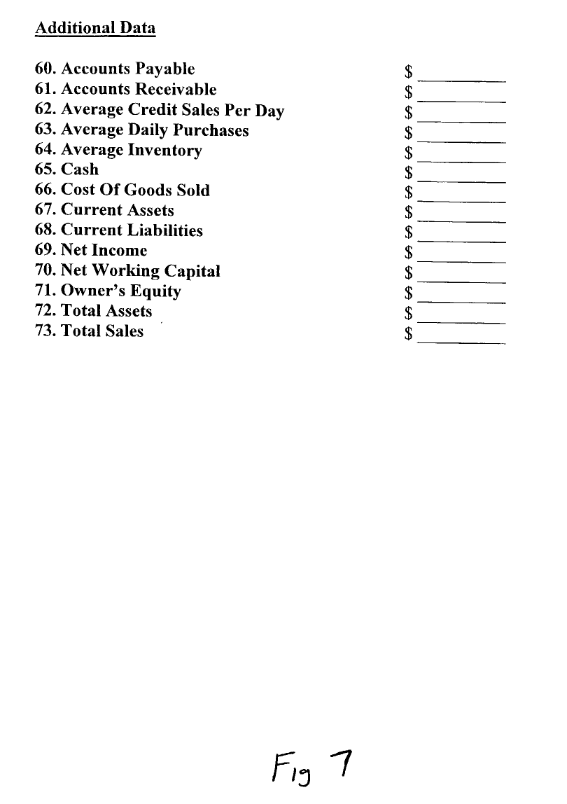

Referring now to FIG. 7, additional data which may be entered is shown. This data includes the following: Accounts Payable, Accounts Receivable, Average Credit Sales per Day, Average Daily Purchases, Average Inventory, Cash, Cost of Goods Sold, Current Assets, Current Liabilities, Net Income, Net Working Capital, Owner's Equity, Total Assets, Total Sales.

Once the data are entered, an analysis of the data will be performed. The information server 12 is programmed to perform a cost of dispensing and financial ratio analysis of the data. The cost of dispensing value is used to quantify the internal operational costs incurred by the pharmacy to dispense a single prescription. A financial ratio analysis uses the relationship between the data entered to assess the economic health of the pharmacy. By comparing the data entered, one may see whether the pharmacy is able to pay its short term debts (i.e., liquidity), long term debt (i.e., solvency), whether the pharmacy's assets are being managed efficiently, and if the pharmacy is earning an adequate profit.

In order to test the solvency and liquidity of the pharmacy, different ratios are calculated. For example, the information server 12 will calculate the current ratio for the pharmacy. The current ratio is calculated by dividing the current assets of the pharmacy by the current liabilities. The current ratio should be at a number of 2 or higher if a pharmacy is to ensure that it has sufficient liquidable resources to meet short term needs. A number of 2 or higher indicates that the pharmacy will be able to meet short term needs even if sales should suddenly fall or expenses increase.

The information server 12 will further calculate an acid test ratio. The acid test ratio is determined by adding the available cash of the pharmacy and the accounts receivable. The sum of these two numbers is divided by the current liabilities. The acid test ratio provides a better indication of a pharmacy's relative liquidity by eliminating inventory, the least liquid current asset. A value of at least 1 is desired.

An accounts payable collection period ratio is also determined by the information server. The accounts payable ratio is calculated by taking the accounts payable and dividing that number by the average daily purchases. The accounts payable ratio will show how efficiently a pharmacy is paying creditors for merchandise purchased by the firm. A value greater than 30 days may suggest that the pharmacy is not taking advantage of some cash discounts that are available.

Other ratio analysis figures may be calculated to test the solvency and liquidity of the pharmacy. The above are given as examples and should not be seen as to limit the scope of the present invention.

The information server 12 will further take the data entered and determine the efficiency of the pharmacy. Some test of efficiency include, but are not limited to, inventory turnover rate, accounts receivable collection period, and net working capital turnover rate. It should be noted again, that these ratio analysis figures are given as examples of figures that may be used to determine the efficiency of the pharmacy. Other figures may be calculated without departing from the spirit and scope of the present invention.

The inventory turnover rate is determined by taking the cost of goods sold and dividing that number by the average inventory. The inventory turnover rate is the most direct measure of how well the single largest asset of the pharmacy is being managed. The higher the inventory turnover rate is, the better the efficiency of the pharmacy. That is, unless there is an unacceptable high level of “stock out” situations. “Stock out” situations can cost the pharmacy clients since clients will go to another pharmacy seeking to have their prescription filled.

Accounts receivable collection period ratio is determined by taking the accounts receivable and dividing this number by the average credit sales per day. The accounts receivable collection period ratio measures the management of credit card sales that have been extended to customers. A value greater than 40 suggests an excess of capital that cannot be used to pay debts or returned to stockholders as profit.

The information server 12 will further determine the net working capital turnover rate. This ratio is determined by taking total sales and dividing this figure by the net working capital. The networking capital turnover rate indicates how efficiently available working capital is being used to generate sales in the pharmacy.

The information server 12 will also determine the profitability and performance of the pharmacy. Tests of profitability and performance include, but is not limited to: gross margin percentage, net income percentage, return of equity ratio, and return of asset ratios.

The gross margin percentage ratio is determined by taking the total sales and subtracting the cost of goods sold. This figure is then divided by the total sales and multiplied by 100. The gross margin percentage reflects the pharmacy's profitability before considering expenses. The gross margin percentage is a good indication of how well the manager of the pharmacy is able to buy merchandise.

The net income percentage measures the profitability of the pharmacy. The net income percentage reflects the net profit margin of the pharmacy after considering expenses. When interpreted within the context of gross margin percentage, the net income percentage provides an indication of how well the manager of the pharmacy is able to control operating expenses. The net income percentage is generally determined by taking the net income divided by sales. This number is then multiplied by 100.

Return on equity is determined by taking the net income and dividing this number by the owner's equity. This number is then multiplied by 100. The return on equity is also known as return on investment (ROI) and return on net worth. This figure is a measure of how effectively the manager has used funds invested in the firm by owners to generate profits. Investors may use this number to compare with rates of return they could achieve from other investment opportunities.

Return on assets is determined by taking net income and dividing this number by total assets. The number is then multiplied by 100. The return on assets reflects how well the manager of the pharmacy has used all available funds to generate profits. Since this figure includes both equity and debt assets, the return on assets ratio is considered a better indicator of the manager's performance.

The information server 12 will prepare a detailed report analyzing the above data and calculated cost of dispensing values and financial ratios. This information may be compared to other reporting periods of the pharmacy or to comparable pharmacies for the same reporting period. The information server 12 has the ability to perform individual cost of dispensing analyses for individual community pharmacies so that they know what their internal operational costs to dispense a prescription are, thereby allowing them to determine whether a given prescription benefit contract and associated dispensing fee is appropriate. Also, the information server 12 has the ability to aggregate these cost of dispensing values across groups of pharmacies for reporting mean and median costs to dispense, thereby allowing groups of pharmacies to better negotiate dispensing fees with payers.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A system for collection and analysis of operational and financial data from community pharmacies comprising, in combination:
an information server for storing and receiving data related to operating the community pharmacy and for performing a cost of dispensing and financial ratio analysis of the data;
a monitor to view the data stored and entered on the information server; and
an information server access box coupled to the monitor and to the information server for accessing the information server and for transferring data to and from the information server.

2. The system for collection and analysis of operational and financial data from community pharmacies in accordance with claim 1 further comprising a firewall coupled to the information server for protecting the information server from unauthorized access.

3. The system for collection and analysis of operational and financial data from community pharmacies in accordance with claim 1 further comprising at least one ISP coupled to the information server.

4. The system for collection and analysis of operational and financial data from community pharmacies in accordance with claim 1 further comprising wireless transmission means coupled to the information server and the information server access box for wirelessly transmitting the data from the information server to and from the information server access box.

5. A computer program product for use with a graphics display device, the computer program product comprising:
a computer usable medium having computer readable program code embodied in the medium for storing and receiving data related to operating a community pharmacy and for performing a cost of dispensing and financial ratio analysis of the data for individual pharmacies and defined groups of pharmacies;
computer readable program code means for calculating cost of dispensing and ratio analysis related to solvency and liquidity of the community pharmacy;
computer readable program code means for calculating ratio analysis related to efficiency of the community pharmacy; and
computer readable program code means for calculating ratio analysis related to profitability and performance of the community pharmacy.

6. A computer program product in accordance with claim 5 wherein the computer readable program code means for calculating ratio analysis related to solvency and liquidity of the community pharmacy calculates a current ratio to determine if the community pharmacy is able to meet short term debts

7. A computer program product in accordance with claim 5 wherein the computer readable program code means for calculating ratio analysis related to solvency and liquidity of the community pharmacy calculates an acid test ratio for solvency and liquidity analysis.

8. A computer program product in accordance with claim 5 wherein the computer readable program code means for calculating ratio analysis related to solvency and liquidity of the community pharmacy calculates an accounts payable collection period for solvency and liquidity analysis.

9. A computer program product in accordance with claim 5 wherein the computer readable program code means for calculating ratio analysis related to efficiency of the community pharmacy calculates an inventory turnover rate for efficiency analysis.

10. A computer program product in accordance with claim 5 wherein the computer readable program code means for calculating ratio analysis related to efficiency of the community pharmacy calculates an accounts receivable collection period for efficiency analysis.

11. A computer program product in accordance with claim 5 wherein the computer readable program code means for calculating ratio analysis related to efficiency of the community pharmacy calculates a net working capital turnover rate for efficiency analysis.

12. A computer program product in accordance with claim 5 wherein the computer readable program code means for calculating ratio analysis related to profitability and performance of the community pharmacy calculates a gross margin percentage for profitability and performance analysis.

13. A computer program product in accordance with claim 5 wherein the computer readable program code means for calculating ratio analysis related to profitability and performance of the community pharmacy calculates a net income percentage for profitability and performance analysis.

14. A computer program product in accordance with claim 5 wherein the computer readable program code means for calculating ratio analysis related to profitability and performance of the community pharmacy calculates a return on equity percentage for profitability and performance analysis.

15. A computer program product in accordance with claim 5 wherein the computer readable program code means for calculating ratio analysis related to profitability and performance of the community pharmacy calculates a return on assets percentage for profitability and performance analysis.
